(19) United States
(12) Patent Application Publication
(10) Pub. No.: US 2024/0277070 A1
(43) Pub. Date: Aug. 22, 2024

(54) AEROSOL GENERATING DEVICE AND OPERATING METHOD THEREOF

(71) Applicant: KT&G CORPORATION, Daejeon (KR)

(72) Inventors: Yong Hwan KIM, Anyang-si (KR); Young Bum Kwon, Yongin-si (KR); Dong Sung Kim, Seoul (KR); Hun II Lim, Seoul (KR)

(73) Assignee: KT&G CORPORATION, Daejeon (KR)

(21) Appl. No.: 18/425,868

(22) Filed: Jan. 29, 2024

(30) Foreign Application Priority Data
Feb. 22, 2023 (KR) 10-2023-0023647
May 18, 2023 (KR) 10-2023-0064537

(51) Int. Cl. A24F 40/51; A24F 40/53; A24F 40/57; H05B 1/02

(52) U.S. Cl. CPC A24F 40/51; A24F 40/53; A24F 40/57; H05B 1/0252

(57) ABSTRACT

An aerosol generating device includes a heater configured to heat at least part of an aerosol generating article, a puff sensor configured to detect a user's puff, and a processor electrically connected to the heater and the puff sensor, wherein the processor is configured to detect a remaining puff number of the aerosol generating article by using the puff sensor, compare a detected remaining puff number with the preset puff number, stop power supply to the heater for a preset time when the detected remaining puff number is less than the preset puff number, and supply power to the heater after the preset time elapses, such that a temperature of the heater reaches a target temperature corresponding to the remaining puff number. In addition, various embodiments may be implemented through the specification.

### CROSS-REFERENCE TO RELATED APPLICATION

This application is based on and claims priority under 35 U.S.C. § 119 to Korean Patent Application No. 10-2023-0023647, filed on Feb. 22, 2023, and Korean Patent Application No. 10-2023-0064537, filed on May 18, 2023, in the Korean Intellectual Property Office, the disclosures of which are incorporated by reference herein in their entireties.

### BACKGROUND

### 1. Field

Various embodiments of the disclosure relate to an aerosol generating device and an operating method of the aerosol generating device, and more particularly, to an aerosol generating device that, based on a remaining puff number of an aerosol generating article, controls power supply to a heater.

### 2. Description of the Related Art

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

When the aerosol generating article is inserted into an accommodation space of the aerosol generating device, the aerosol generating device may heat the aerosol generating article according to a preset temperature profile. In this case, the temperature profile may refer to temperature change data of a heater or the aerosol generating article during smoking. Accordingly, the preset temperature profile may be set such that a constant amount of aerosol may be generated as the aerosol generating article is heated.

### SUMMARY

When an aerosol generating device controls power supply to a heater according to a temperature profile over time, an inconsistent amount of aerosol may be generated during a user's smoking. In particular, the amount of atomization may decrease towards the latter part of the smoking, which may provide a user with an unsatisfactory smoking experience.

Also, although puff cycles during smoking operation are different from each other for each user, when the aerosol generating device controls the power supply according to the temperature profile over time, the different amount of atomization, taste, and so on may be provided to each user, and thereby, a user's enjoyment of smoking may be reduced.

Various embodiments of the disclosure provide an aerosol generating device that may generate a constant amount of aerosol during smoking by controlling power supply to a heater based on the remaining puff number of the aerosol generating article.

The problems to be solved through the embodiments of the present disclosure are not limited to the above-mentioned problems, and the problems not mentioned may be clearly understood by those skilled in the art from the present specification and the attached drawings. It could be.

Additional aspects will be set forth in part in the description which follows and, in part, will be apparent from the description, or may be learned by practice of the presented embodiments of the disclosure.

According to an embodiment, an aerosol generating device includes a heater configured to heat at least a part of an aerosol generating article, a puff sensor configured to detect a user's puff, and a processor electrically connected to the heater and the puff sensor, wherein the processor is configured to detect a remaining puff number of the aerosol generating article by using the puff sensor, compare a detected remaining puff number with the preset puff number, stop power supply to the heater for a preset time when the detected remaining puff number is less than the preset puff number, and supply power to the heater after the preset time elapses such that a temperature of the heater reaches a target temperature corresponding to the remaining puff number.

According to another embodiment, an operating method of an aerosol generating device includes detecting a remaining puff number of an aerosol generating article by using a puff sensor configured to detect a user's puff, comparing a detected remaining puff number with a preset puff number, stopping, for a preset time, power supply to a heater configured to heat at least part of the aerosol generating article when a detected remaining puff number is less than the preset puff number, and supplying power to the heater after the preset time elapses such that a temperature of the heater reaches a target temperature corresponding to the remaining puff number.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2 is a flowchart illustrating a method of controlling power supply to a heater by an aerosol generating device, according to an embodiment;

FIG. 3A is a graph of power supply according to a remaining puff number of an aerosol generating device according to an embodiment;

FIG. 3B is a graph of a temperature profile according to a remaining puff number of an aerosol generating device according to an embodiment;

FIG. 4A is a graph of power supply according to a remaining puff number of an aerosol generating device according to another embodiment;

FIG. 4B is a graph of a temperature profile according to a remaining puff number of an aerosol generating device according to another embodiment;

FIG. 5 is a flowchart illustrating a method of controlling power supply to a heater by an aerosol generating device according to an embodiment when a user's puff is not detected;

FIG. 6 is a graph of power supply of the aerosol generating device of FIG. 5;

FIG. 7 is a flowchart illustrating a method in which an aerosol generating device changes a preset puff number based on an initial temperature increase rate of a heater, according to an embodiment;

FIG. 8 is an example in which an aerosol generating device according to an embodiment reduces a preset puff number based on an initial temperature increase rate of a heater;

FIG. 9 is an example in which an aerosol generating device according to an embodiment increases a preset puff number based on an initial temperature increase rate of a heater; and

FIG. 10 is a block diagram of an aerosol generating device according to another embodiment.

### DETAILED DESCRIPTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

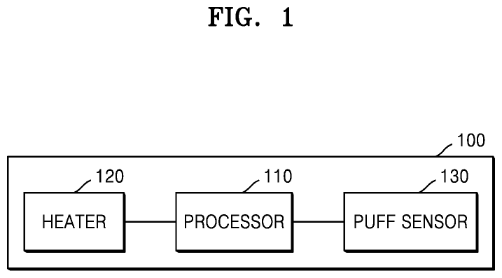

FIG. 1 is a block diagram of an aerosol generating device according to one embodiment.

Referring to FIG. 1, an aerosol generating device 100 may include a processor 110, a heater 120, and a puff sensor 130. Hardware components included in the aerosol generating device 100 are not limited to the components illustrated in FIG. 1. Those skilled in the art related to the present embodiment may understand that some of the hardware components illustrated in FIG. 1 may be omitted, or new components may be added to the hardware components according to a design of the aerosol generating device 100.

Hereinafter, operations of the respective components included in the aerosol generating device 100 are described without limiting spaces in which the respective components are provided.

In one embodiment, the heater 120 may heat at least a part of an aerosol generating article inserted into the aerosol generating device 100. For example, the heater 120 may receive power from a battery (not illustrated) by control of the processor 110 and generate an aerosol by heating at least a part of the aerosol generating article by using the supplied power.

In one embodiment, the heater 120 may be a resistance heating type heater or an induction heating type heater. For example, when the heater 120 is the resistance heating type heater, the heater 120 may be made of any electrically resistive material or may be made of a metal heating wire, a metal heating plate with electrically conductive tracks, a ceramic heating element, or so on. In another example, when the heater 120 is the induction heating type heater, the heater 120 may also be implemented as a susceptor that generates heat by a magnetic field applied by an induction coil.

In one embodiment, the puff sensor 130 may detect a user's puff and transmit the detected information to the processor 110.

In one embodiment, the puff sensor 130 may be a pressure sensor that detects a user's puff by measuring pressure due to a change in internal airflow of the aerosol generating device 100. For example, the puff sensor 130 may be in an airflow passage in the aerosol generating device 100, an end of an opening, or so on to measure an internal pressure of the aerosol generating device 100, but a placement region of the puff sensor 130 is not limited thereto. In this case, the puff sensor 130 may be any one of an absolute pressure sensor, a gauge pressure sensor, and a differential pressure sensor.

However, the puff sensor 130 is not limited thereto and may be at least one of a temperature sensor, a humidity sensor, and a sensor for detecting a change in electrical characteristics.

In one embodiment, the processor 110 may detect a remaining puff number of an aerosol generating article by using the puff sensor 130. In this case, the “remaining puff number” refers to the remaining number of times by which a user may puff an aerosol generating article, and the processor 110 may detect a remaining puff number by subtracting the detected puff number from the number of possible puffs for the aerosol generating article.

For example, when the number of possible puffs for one aerosol generating article is 15 and the number of puffs previously inhaled by a user is 10, the processor 110 may detect a remaining puff number of 5.

In one embodiment, the processor 110 may control power supply to the heater 120 by comparing the detected remaining puff number with a preset puff number. For example, the processor 110 may control the power supply to the heater 120 based on pulse width modulation (PWM) control, proportional integral differential (PID) control, or so on.

In this case, the “preset puff number” may mean a reference puff number at which the processor 110 stops power supply to the heater 120. For example, when the remaining puff number (for example, 13) detected by the puff sensor 130 is more than the preset puff number (for example, 12), the processor 110 may supply power to the heater 120. In another example, when the remaining puff number (for example, 11) detected by the puff sensor 130 is less than the preset puff number (for example, 12), the processor 110 may stop power supply to the heater 120.

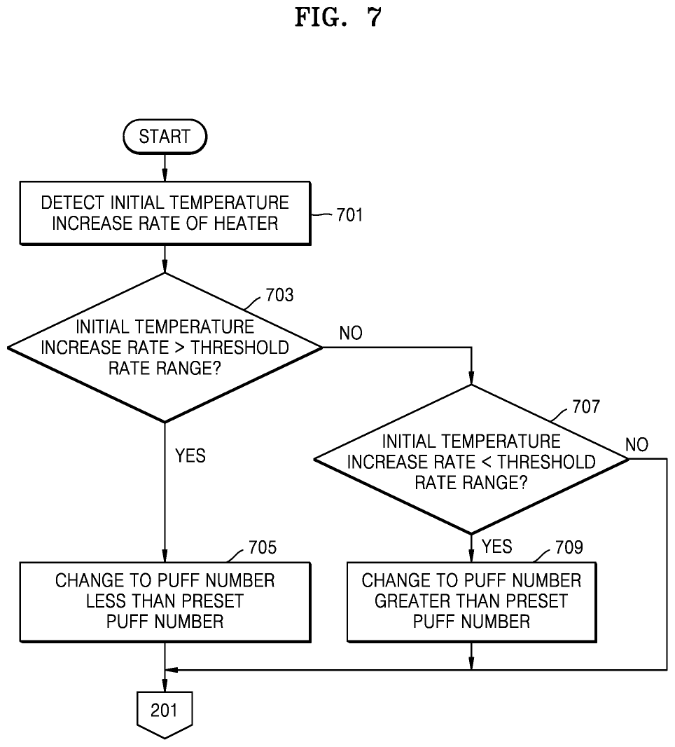

In one embodiment, the preset puff number may be changed based on an initial temperature increase rate of the heater 120, and detailed descriptions thereof are made below with reference to FIGS. 7 to 9.

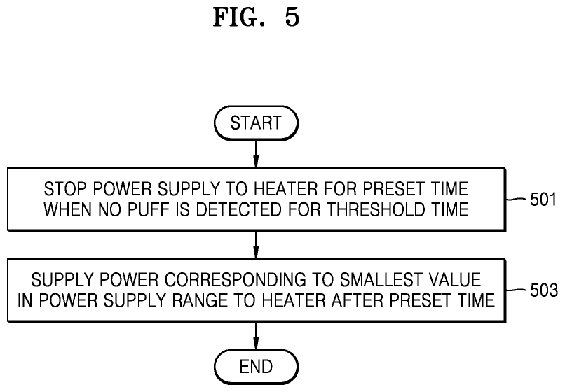

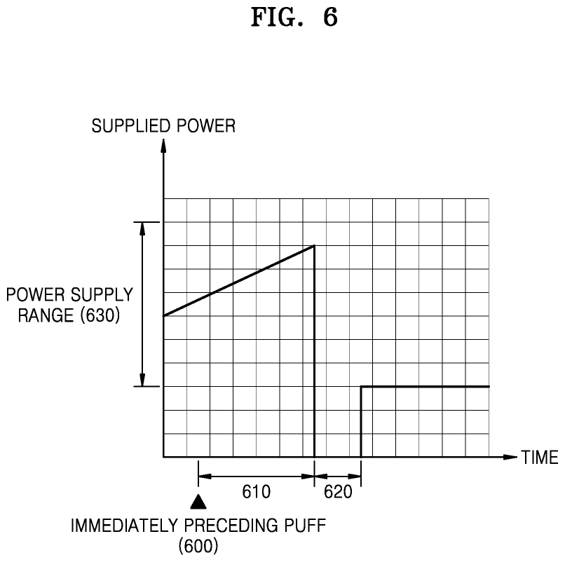

Also, when no puff is detected for a threshold time after a user's puff is detected by the puff sensor 130, the processor 110 may stop power supply to the heater 120 for a preset time, and detailed descriptions thereof are made below with reference to FIGS. 5 and 6.

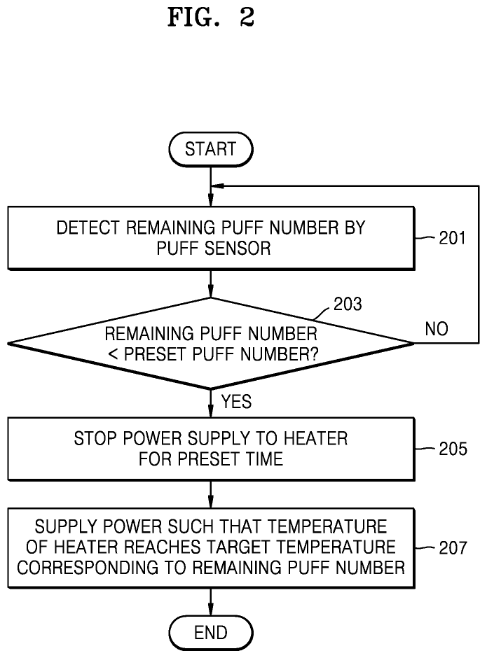

FIG. 2 is a flowchart illustrating a method of controlling power supply to a heater by an aerosol generating device, according to an embodiment. In descriptions being made with reference to FIG. 2, the descriptions that correspond to, are the same as, or are similar to the descriptions given above may be omitted.

Referring to FIG. 2, a processor (for example, the processor 110 of FIG. 1) may detect a remaining puff number by using a puff sensor (for example, the puff sensor 130 of FIG. 1) in operation 201. For example, as an aerosol generating article is inserted into an aerosol generating device (for example, the aerosol generating device 100 of FIG. 1), the processor 100 may supply power for preheating of a heater (for example, the heater 120 of FIG. 1). Also, when a user starts smoking after a preheating section of the heater 120 ends, the processor 110 may detect the user's puff through the puff sensor 130. In this case, the processor 110 may detect a remaining puff number by subtracting the detected puff number from the number of possible puffs (that is, the greatest puff number) for the inserted aerosol generating article.

For example, when the greatest puff number for one aerosol generating article is 15 and the number of puffs detected as being inhaled by the user is 10, the processor 110 may detect a remaining puff number of 5.

In one embodiment, the number of possible puffs for an inserted aerosol generating article may be stored in a separate memory (not illustrated). In this case, when the numbers of possible puffs are different from each other depending on the type of aerosol generating articles, a memory device may store the greatest puff number for each type of aerosol generating articles. For example, when the greatest puff number for a first aerosol generating article (a first type) is 15 and the greatest puff number for a second aerosol generating article (a second type) is 10, the memory device may store data (for example, the greatest puff number of “15” for the first aerosol generating product is , and the greatest puff number of “10” for the second aerosol generating article) on the greatest puff number according to the type of each aerosol generating article.

Thereafter, the processor 110 may detect the type of aerosol generating article inserted into the aerosol generating device 100 by using a separate sensor (not illustrated) and may obtain the greatest puff number data according to the detected type of aerosol generating article from the memory device.

According to one embodiment, the processor 110 may compare the remaining puff number detected in operation 203 with the preset puff number. In this case, the “preset puff number” may mean a reference puff number at which the processor 110 stops power supply to the heater 120.

In one embodiment, when the detected remaining puff number is less than the preset puff number, the processor 110 may stop power supply to the heater 120 for a preset time in operation 205. In another embodiment, when the detected remaining puff number is greater than or equal to the preset puff number, the processor 110 may return to operation 201 and repeat the following operations.

For example, when the detected remaining puff number is greater than or equal to the preset puff number, the processor 110 may supply power to the heater 120 based on a first temperature profile, and when the detected remaining puff number is less than the preset puff number, the processor 110 may stop power supply to the heater 120 for the preset time.

In this case, the “first temperature profile” is a temperature profile for a remaining puff number detected by the puff sensor 130 and may include a temperature increase section in which the temperature of the heater 120 increases to a threshold temperature.

Also, the “preset time” during which power supply stops may mean the time taken for the temperature of the heater 120 to decrease to a preset temperature, and may be the time corresponding to the preset puff number (for example, 2 to 5 number of times) of a user Also, the “preset time” may be set in advance according to a manufacturer's design.

For example, when the remaining puff number detected by the puff sensor 130 is 11 and the preset puff number is 12, the processor 110 may stop power supply to the heater 120 for the preset time (for example, 30 seconds). However, even when power supply to the heater 120 stops for the preset time, a user may perform smoking during the preset time because the heater 120 still has a substantially high temperature (that is, the temperature at which an aerosol may be generated by heating an aerosol generating article).

Compared to the known method of lowering the temperature of a heater by reducing the supplied power, the present embodiment may increase power efficiency by stopping power supply to the heater 120 for the preset time. That is, even when the power supply stops for the preset time, the temperature of the heater 120 may gradually decrease, and accordingly, by adjusting the “preset time” during which power supply stops, the temperature of the heater 120 may decrease to a target temperature, and thereby, power efficiency may be increased.

According to one embodiment, when power supply to the heater 120 stops and the preset time elapses, the processor 110 may supply power based on a second temperature profile such that the temperature of the heater 120 reaches the target temperature corresponding to the remaining puff number in operation 207.

In this case, the “remaining puff number” may mean the number of puffs remaining at a time when the preset time elapses after power supply to the heater 120 stops.

Also, the “second temperature profile” is a temperature profile for the remaining puff number detected by the puff sensor 130, and as the remaining puff number decreases, the target temperature may increase.

For example, when the remaining puff number detected by the puff sensor 130 is 11 and the preset puff number is 12, the processor 110 may stop power supply to the heater 120 for a preset time (for example, 30 seconds). In this case, when puffs are performed twice by a user for a preset time, the processor 110 may detect that the remaining puff number at the time when the preset time elapses is 9.

Thereafter, the processor 110 may supply power to the heater 120 such that the temperature of the heater 120 reaches a target temperature (for example, 250° C.) corresponding to “8”, which is a remaining puff number. Also, as the remaining puff number decreases, for example, “7 number of times”, “6 number of times”, “5 number of times”, or so on, the target temperature corresponding to the remaining puff number may increase, for example, “265° C.”, “280° C.”, “295° C.”, or so on.

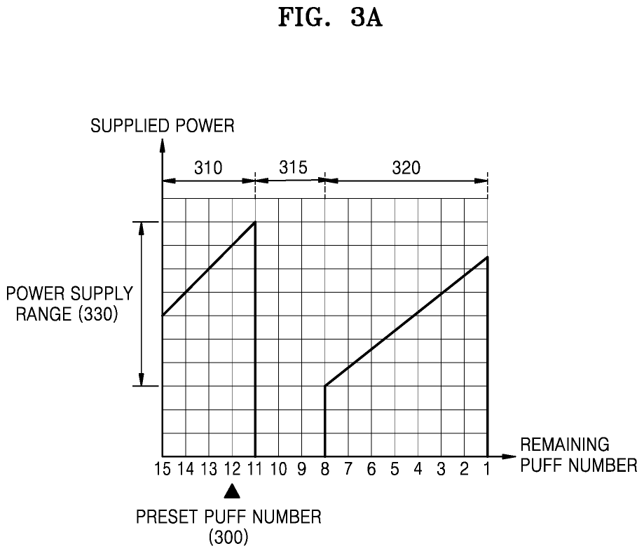

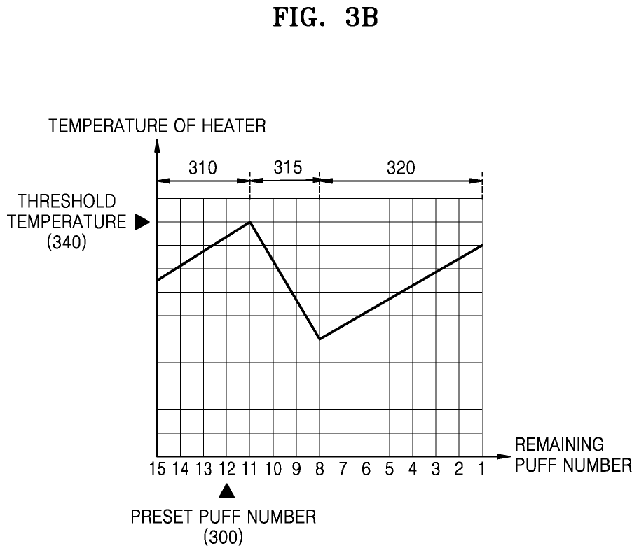

FIG. 3A is a graph of the supplied power according to a remaining puff number of an aerosol generating device according to one embodiment. FIG. 3B is a graph of a temperature profile according to the remaining puff number of an aerosol generating device according to one embodiment.

Referring to FIGS. 3A and 3B, a processor (for example, the processor 110 of FIG. 1) may control power supply to a heater (for example, the heater 120 of FIG. 1) in a first section 310, a second section 315, and a third section 320. In this case, the first section 310 may correspond to a section in which a remaining puff number is 15 to 11, the second section 315 may correspond to a section in which the remaining puff number is 11 to 8, and the third section 320 may correspond to a section in which the remaining puff number is 8 to 1, and in the remaining puff number (for example, “11 number of times” and “8 number of times”) overlapping respective sections, power supply to the heater 120 may stop and restart.

In one embodiment, the first section 310 may correspond to a section in which power is supplied within a power supply range 330 to the heater 120 such that the temperature of the heater 120 may be controlled based on the first temperature profile. The second section 315 may correspond to a section in which power supply to the heater 120 stops such that the temperature of the heater 120 substantially decreases. The third section 320 may correspond to a section in which power is supplied within the power supply range 330 to the heater 120 such that the temperature of the heater 120 may be controlled based on the second temperature profile that is different from the first temperature profile.

In this case, the first temperature profile and the second temperature profile may include a temperature increase section in which the temperature of the heater 120 increases as the remaining puff number decreases, and in particular, the first temperature profile may include a temperature increase section in which the temperature of the heater 120 increases to a threshold temperature 340.

For example, when the preset puff number 300, which is a reference puff number at which the processor 110 stops power supply to the heater 120, is set to “12”, the processor 110 may stop the power supply to the heater 120 in the first section 310 after power is supplied to the heater 120 until the remaining puff number reaches ‘11 number of times’ which is less than the preset puff number 300.

In this case, the final power supplied to the heater 120 in the first section 310 may be the greatest value of the power supply range 330, and accordingly, the temperature of the heater 120 may increase to the threshold temperature 340.

The processor 110 may stop power supply to the heater 120 in the second section 315, and the second section 315 may correspond to a preset time (for example, 30 seconds). In this case, the temperature of the heater 120 may gradually decrease from the threshold temperature 340 in the second section 315, and a user's smoking may be detected in the second section 315. For example, even when power supply to the heater 120 stops in the second section 315, the puff number may be counted as a user's puff is detected.

The processor 110 may restart power supply to the heater 120 as the user's puff is detected after the preset time elapses. For example, when the remaining puff number is “8” after a preset time (for example, 30 seconds) elapses, the processor 110 may supply power to the heater 120 such that the temperature of the heater 120 reaches a target temperature (for example, 250° C.) corresponding to “8” which is the remaining puff number.

In this case, an initial power supplied to the heater 120 in the third section 320 may be the smallest value in the power supply range 330, and accordingly, the temperature of the heater 120 may reach the target temperature. Thereafter, as the remaining puff number decreases in the third section 320, the target temperature of the heater 120 increases, and accordingly, the processor 110 may gradually increase the power supplied to the heater 120.

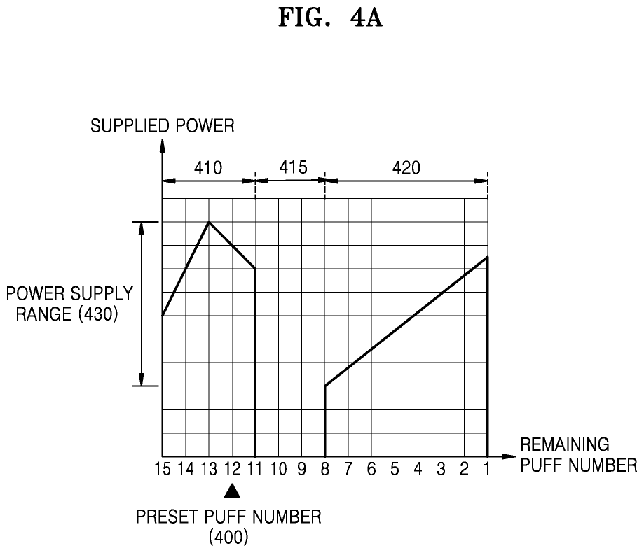

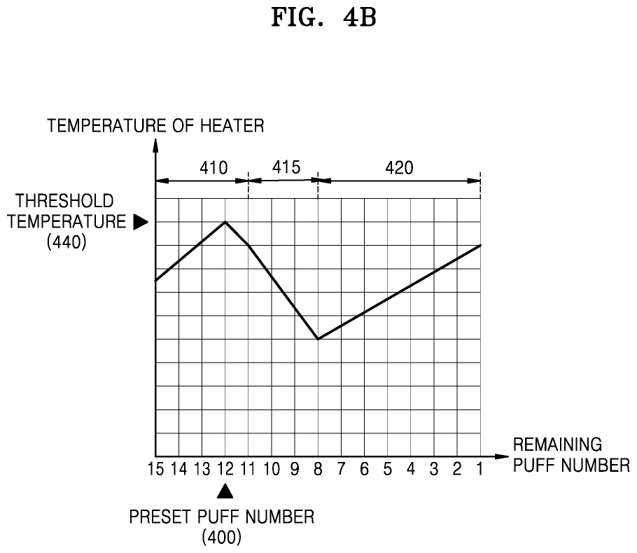

FIG. 4A is a graph of the supplied power according to a remaining puff number of an aerosol generating device according to another embodiment. FIG. 4B is a graph of a temperature profile according to a remaining puff number of an aerosol generating device according to another embodiment.

Referring to FIGS. 4A and 4B, a processor (for example, the processor 110 of FIG. 1) may control the power supplied to a heater (for example, the heater 120 of FIG. 1) in a first section 410, a second section 415, and a third section 420. In this case, the first section 410 may correspond to a section in which the remaining puff number is 15 to 11, the second section 415 may correspond to a section in which the remaining puff number is 11 to 8, and the third section 420 may correspond to a section in which the remaining puff number is 8 to 1, and in the remaining puff number (for example, “11 number of times” and “8 number of times”) overlapping respective sections, power supply to the heater 120 may stop and restart.

In one embodiment, the first section 410 may correspond to a section in which power is supplied within a power supply range 430 to the heater 120 such that the temperature of the heater 120 may be controlled based on the first temperature profile. The second section 415 may correspond to a section in which power supply to the heater 120 stops such that the temperature of the heater 120 substantially decreases. The third section 420 may correspond to a section in which power is supplied within the power supply range 430 to the heater 120 such that the temperature of the heater 120 may be controlled based on the second temperature profile that is different from the first temperature profile.

In this case, the first temperature profile may include a temperature increase section in which the temperature of the heater 120 increases to the threshold temperature 440 and a temperature decrease section in which the temperature of the heater 120 decreases after reaching the threshold temperature 440, and the second temperature profile may include only a temperature increase section in which the temperature of the heater 120 increases as the remaining puff number decreases.

For example, when the preset puff number 400, which is a reference puff number at which the processor 110 stops power supply to the heater 120, is set to “12”, the processor 110 may stop the power supply to the heater 120 in the first section 410 after power is supplied to the heater 120 until the remaining puff number reaches ‘11 number of times’ which is less than the preset puff number 400.

In this case, the final power supplied to the heater 120 in the first section 410 may be power that is less than the greatest value of the power supply range 430, and accordingly, the temperature of the heater 120 may decrease after increasing to the threshold temperature 440.

The processor 110 may stop power supply to the heater 120 in the second section 415, and the second section 415 may correspond to a preset time (for example, 30 seconds). In this case, the temperature of the heater 120 may gradually decrease in the second section 415, and a user's smoking may be detected in the second section 415. For example, even when power supply to the heater 120 stops in the second section 415, the puff number may be counted as a user's puff is detected.

The processor 110 may restart the power supply to the heater 120 as the user's puff is detected after the preset time elapses. For example, when the remaining puff number is “8” after a preset time (for example, 30 seconds) elapses, the processor 110 may supply power to the heater 120 such that the temperature of the heater 120 reaches a target temperature (for example, 250° C.) corresponding to “8” which is the remaining puff number.

In this case, an initial power supplied to the heater 120 in the third section 420 may be the smallest value in the power supply range 430, and accordingly, the temperature of the heater 120 may reach the target temperature. Thereafter, as the remaining puff number decreases in the third section 420, the target temperature of the heater 120 increases, and accordingly, the processor 110 may gradually increase the power supplied to the heater 120.

FIG. 5 is a flowchart illustrating a method of controlling power supply to a heater by an aerosol generating device according to one embodiment when a user's puff is not detected.

Referring to FIG. 5, a processor (for example, the processor 110 of FIG. 1) may stop power supply to a heater (for example, the heater 120 of FIG. 1) for a preset time when no puff is detected for a threshold time in operation 501 after a user's puff is detected by a puff sensor (for example, the puff sensor 130 of FIG. 1).

For example, the processor 110 may stop power supply to the heater 120 for a preset time (for example, 20 seconds) when no puff is detected for a threshold time (for example, 1 minute) after a user's immediately preceding puff is detected by the puff sensor 130.

In controlling power supply to the heater 120 based on the number of puffs of a user by an aerosol generating device (for example, the aerosol generating device 100 of FIG. 1) according to the present disclosure, when a constant power is continuously supplied to the heater 120 even though a user's puff is not detected for a long period of time, there is a possibility that defects, such as overheating of the heater 120 and malfunction of the aerosol generating device 100, may occur. Accordingly, when a user's puff is not detected during a threshold time, the processor 110 may determine that the user's puff is temporarily stopped and may stop power supply to the heater 120 for a preset time.

According to one embodiment, the processor 110 may supply power corresponding to the smallest value in a power supply range to the heater 120 in operation 503 after a preset time elapses.

For example, the processor 110 may restart power supply to the heater 120 after a preset time (for example, 20 seconds) elapses from the time at which power supply to the heater 120 stops. In this case, the power supplied to the heater 120 may correspond to the smallest value in the power supply range for the heater 120.

Accordingly, it may be determined that a user's puff is temporarily stopped, and the temperature of the heater 120 may be prevented from substantially decreasing to a lower temperature (that is, a temperature at which an aerosol may not be generated from an aerosol generating article) while stopping power supply to the heater 120 for a preset time. However, in order to prevent a sudden increase in temperature of the heater 120 and unnecessary power consumption, the processor 110 may supply the power corresponding to the smallest value in a power supply range to the heater 120.

FIG. 6 is a graph of the power supplied to the aerosol generating device of FIG. 5.

Referring to FIG. 6, a processor (for example, the processor 110 of FIG. 1) may detect a user's immediately preceding puff 600 through a puff sensor (for example, the puff sensor 130 of FIG. 1). Thereafter, when the user's puff is not detected for a threshold time 610 after the user's immediately preceding puff 600, the processor 110 may stop power supply to a heater (for example, the heater 120 of FIG. 1) for a preset time 620.

Thereafter, the processor 110 may restart the power supply to the heater 120 after the preset time 620 elapses from the time when power supply to the heater 120 is stopped. When restarting the power supply after the preset time 620 elapses, the processor 110 may supply the power corresponding to the smallest value in the power supply range to the heater 120.

FIG. 7 is a flowchart illustrating a method of changing a preset puff number based on an initial temperature increase rate of a heater by an aerosol generating device according to one embodiment. FIG. 7 is a flowchart illustrating operations prior to operation 201 of FIG. 2.

Referring to FIG. 7, a processor (for example, the processor 110 of FIG. 1) may detect an initial temperature increase rate of a heater (for example, the heater 120 of FIG. 1) in operation 701. In this case, the “initial temperature increase rate” may mean a rate at which the temperature of the heater 120 reaches a target preheating temperature in a preheating section in which the heater 120 is preheated. The initial temperature increase rate of the heater 120 may change depending on states of an aerosol generating article inserted into an aerosol generating device (for example, the aerosol generating device 100 of FIG. 1).

According to one embodiment, the processor 110 may determine whether an initial temperature increase rate of the heater 120 exceeds a threshold rate range in operation 703. In this case, the “threshold rate range” may mean a temperature increase rate range of the heater 120 in the preheating section when the aerosol generating article inserted into the aerosol generating device 100 is in a normal state.

In one embodiment, when the initial temperature increase rate of the heater 120 exceeds the threshold rate range, the processor 110 may determine that a thickness of the inserted aerosol generating article is in a first abnormal state in which the thickness is too small. That is, the first abnormal state may mean a state in which the heat generated from the heater 120 is not transferred to the aerosol generating article because the thickness of the aerosol generating article is too small.

According to one embodiment, when the initial temperature increase rate of the heater 120 exceeds the threshold rate range, the processor 110 may change the preset puff number to a lower puff number than the preset puff number in operation 705. For example, the processor 110 may supply power to the heater 120 based on a profile of a temperature increase section in which the temperature of the heater 120 increases until the remaining puff number of the aerosol generating article reaches a preset puff number. However, when the aerosol generating article corresponds to the first abnormal state and the heat generated from the heater 120 is not transferred, the processor 110 may change the preset puff number to a puff number lower than the preset puff number, thereby setting the temperature increase section, in which the temperature of the heater 120 increases, to be longer.

According to one embodiment, the processor 110 may determine whether the initial temperature increase rate of the heater 120 is less than the threshold rate range in operation 707.

In one embodiment, when the initial temperature increase rate of the heater 120 is less than the threshold rate range, the processor 110 may determine that the inserted aerosol generating article is in a second abnormal state in which the inserted aerosol generating article has a large amount of moisture. That is, the second abnormal state may mean an over-humidity state in which the aerosol generating article has a large amount of moisture due to external environmental conditions or manufacturing conditions.

According to one embodiment, when the initial temperature increase rate of the heater 120 is less than the threshold rate range, the processor 110 may change the preset puff number to a higher puff number than the preset puff number in operation 709. For example, the processor 110 may supply power to the heater 120 based on a profile of a temperature increase section in which the temperature of the heater 120 increases until the remaining puff number of the aerosol generating article reaches a preset puff number. However, when the aerosol generating article corresponds to the second abnormal state and an excessively large amount of water vapor is generated from the aerosol generating article, the processor 110 may change the preset puff number to a puff number lower than the preset puff number, thereby setting the temperature increase section, in which the temperature of the heater 120 increases, to be shorter.

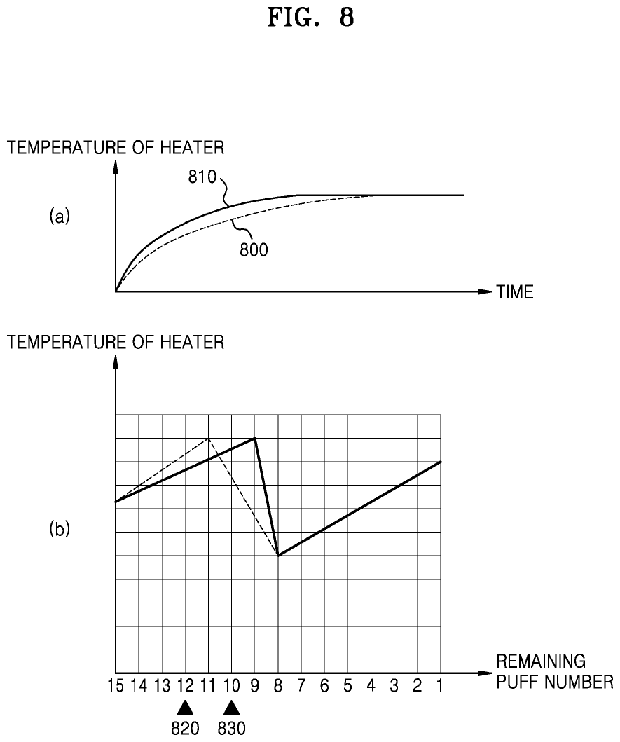

FIG. 8 is an example in which an aerosol generating device according to one embodiment reduces a preset puff number based on an initial temperature increase rate of a heater.

Referring to a graph (a) of FIG. 8, a temperature increase rate of a heater (for example, the heater 120 of FIG. 1) in a preheating section of the heater depends on a state of an aerosol generating article inserted into an aerosol generating device (for example, the aerosol generating device 100 of FIG. 1).

For example, when the state of the aerosol generating article inserted into the aerosol generating device 100 is in a normal state 800, the temperature of the heater 120 may increase at a rate in a threshold rate range in the preheating section. In another example, when the state of the aerosol generating article inserted into the aerosol generating device 100 is in a first abnormal state (that is, a state in which a thickness of the aerosol generating article is too small) 810, the temperature of the heater 120 may increase at a rate exceeding the threshold rate range in the preheating section.

Referring to graph (b) of FIG. 8, the processor 110 may change the preset puff number based on an initial temperature increase rate of the heater 120 in the preheating section. For example, when the state of the aerosol generating article inserted into the aerosol generating device 100 is in the normal state 800, the initial temperature increase rate of the heater 120 is within the threshold rate range, and the processor 110 may maintain an existing preset puff number 820 without changing the preset puff number. In another example, when the state of the aerosol generating article inserted into the aerosol generating device 100 is in the first abnormal state 810, the initial temperature increase rate of the heater 120 exceeds the threshold rate range, and the processor 110 may change the existing preset puff number 820 to a new reference puff number 830.

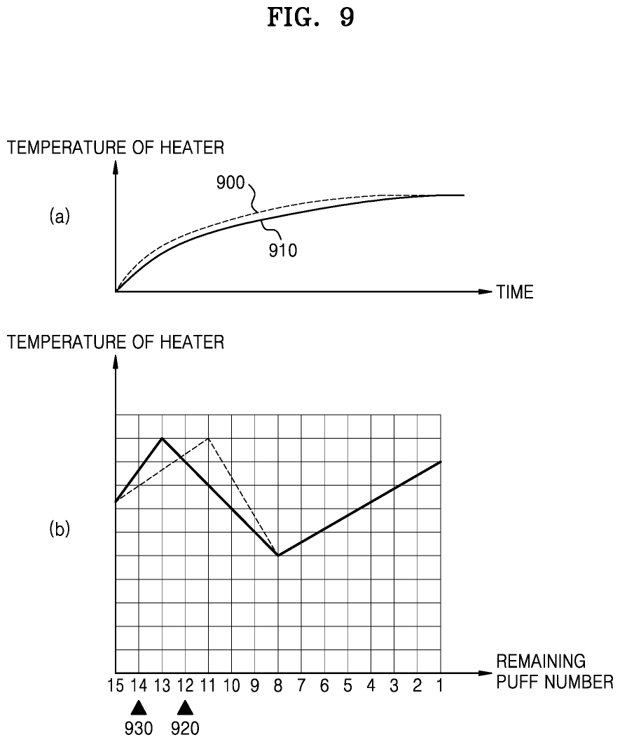

FIG. 9 is an example in which an aerosol generating device according to one embodiment increases a preset puff number based on an initial temperature increase rate of a heater.

Referring to a graph (a) of FIG. 8, a temperature increase rate of a heater (for example, the heater 120 of FIG. 1) in a preheating section of the heater depends on a state of an aerosol generating article inserted into an aerosol generating device (for example, the aerosol generating device 100 of FIG. 1).

For example, when the state of the aerosol generating article inserted into the aerosol generating device 100 is in a normal state 900, the temperature of the heater 120 may increase at a rate in a threshold rate range in the preheating section. In another example, when the state of the aerosol generating article inserted into the aerosol generating device 100 is a second abnormal state (that is, an over-humidity state of the aerosol generating article) 910, the temperature of the heater 120 may increase at a rate below the threshold rate range in the preheating section.

Referring to graph (b) of FIG. 8, the processor 110 may change the preset puff number based on an initial temperature increase rate of the heater 120 in the preheating section. For example, when the state of the aerosol generating article inserted into the aerosol generating device 100 is in the normal state 900, the initial temperature increase rate of the heater 120 is within the threshold rate range, and the processor 110 may maintain an existing preset puff number 920 without changing the preset puff number. In another example, when the state of the aerosol generating article inserted into the aerosol generating device 100 is in the second abnormal state 910, the initial temperature increase rate of the heater 120 below the threshold rate range, and the processor 110 may change the existing preset puff number 920 to a new reference puff number 830.

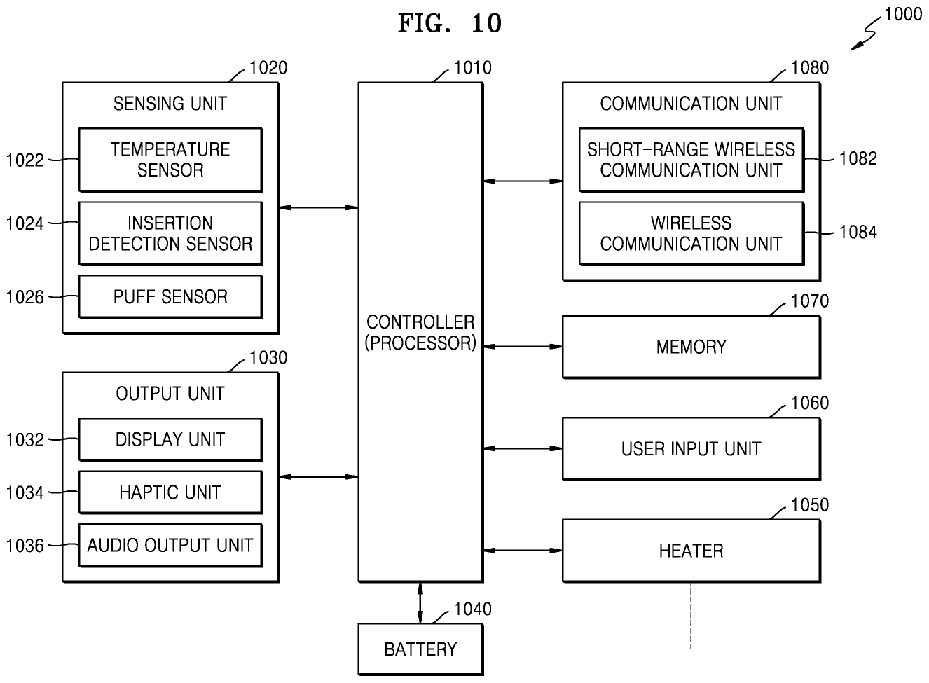

FIG. 10 is a block diagram of an aerosol generating device 1000 according to another embodiment.

The aerosol generating device 1000 may include a controller 1010, a sensing unit 1020, an output unit 1030, a battery 1040, a heater 1050, a user input unit 1060, a memory 1070, and a communication unit 1080. However, the internal structure of the aerosol generating device 1000 is not limited to those illustrated in FIG. 10. That is, according to the design of the aerosol generating device 1000, it will be understood by one of ordinary skill in the art that some of the components shown in FIG. 10 may be omitted or new components may be added.

The sensing unit 1020 may sense a state of the aerosol generating device 1000 and a state around the aerosol generating device 1000, and transmit sensed information to the controller 1010. Based on the sensed information, the controller 1010 may control the aerosol generating device 1000 to perform various functions, such as controlling an operation of the heater 1050, limiting smoking, determining whether an aerosol generating article (e.g., a cigarette, a cartridge, or the like) is inserted, displaying a notification, or the like.

The sensing unit 1020 may include at least one of a temperature sensor 1022, an insertion detection sensor, and a puff sensor 1026, but is not limited thereto.

The temperature sensor 1022 may sense a temperature at which the heater 1050 (or an aerosol generating material) is heated. The aerosol generating device 1000 may include a separate temperature sensor for sensing the temperature of the heater 1050, or the heater 1050 may serve as a temperature sensor. Alternatively, the temperature sensor 1022 may also be arranged around the battery 1040 to monitor the temperature of the battery 1040.

The insertion detection sensor 1024 may sense insertion and/or removal of an aerosol generating article. For example, the insertion detection sensor 1024 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1026 may sense a user's puff on the basis of various physical changes in an airflow passage or an airflow channel. For example, the puff sensor 1026 may sense a user's puff on the basis of any one of a temperature change, a flow change, a voltage change, and a pressure change.

The sensing unit 1020 may include, in addition to the temperature sensor 1022, the insertion detection sensor 1024, and the puff sensor 1026 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1030 may output information on a state of the aerosol generating device 1000 and provide the information to a user. The output unit 1030 may include at least one of a display unit 1032, a haptic unit 1034, and a sound output unit 1036, but is not limited thereto. When the display unit 1032 and a touch pad form a layered structure to form a touch screen, the display unit 1032 may also be used as an input device in addition to an output device.

The display unit 1032 may visually provide information about the aerosol generating device 1000 to the user. For example, information about the aerosol generating device 1000 may mean various pieces of information, such as a charging/discharging state of the battery 1040 of the aerosol generating device 1000, a preheating state of the heater 1050, an insertion/removal state of an aerosol generating article, or a state in which the use of the aerosol generating device 1000 is restricted (e.g., sensing of an abnormal object), or the like, and the display unit 1032 may output the information to the outside. The display unit 1032 may be, for example, a liquid crystal display panel (LCD), an organic light-emitting diode (OLED) display panel, or the like. In addition, the display unit 1032 may be in the form of a light-emitting diode (LED) light-emitting device.

The haptic unit 1034 may tactilely provide information about the aerosol generating device 1000 to the user by converting an electrical signal into a mechanical stimulus or an electrical stimulus. For example, the haptic unit 1034 may include a motor, a piezoelectric element, or an electrical stimulation device.

The sound output unit 1036 may audibly provide information about the aerosol generating device 1000 to the user. For example, the sound output unit 1036 may convert an electrical signal into a sound signal and output the same to the outside.

The battery 1040 may supply power used to operate the aerosol generating device 1000. The battery 1040 may supply power such that the heater 1050 may be heated. In addition, the battery 1040 may supply power required for operations of other components (e.g., the sensing unit 1020, the output unit 1030, the user input unit 1060, the memory 1070, and the communication unit 1080) in the aerosol generating device 1000. The battery 1040 may be a rechargeable battery or a disposable battery. For example, the battery 1040 may be a lithium polymer (LiPoly) battery, but is not limited thereto.

The heater 1050 may receive power from the battery 1040 to heat an aerosol generating material. Although not illustrated in FIG. 10, the aerosol generating device 1000 may further include a power conversion circuit (e.g., a direct current (DC)/DC converter) that converts power of the battery 1040 and supplies the same to the heater 1050. In addition, when the aerosol generating device 1000 generates aerosols in an induction heating method, the aerosol generating device 1000 may further include a DC/alternating current (AC) that converts DC power of the battery 1040 into AC power.

The controller 1010, the sensing unit 1020, the output unit 1030, the user input unit 1060, the memory 1070, and the communication unit 1080 may each receive power from the battery 1040 to perform a function. Although not illustrated in FIG. 10, the aerosol generating device 1000 may further include a power conversion circuit that converts power of the battery 1040 to supply the power to respective components, for example, a low dropout (LDO) circuit, or a voltage regulator circuit.

In an embodiment, the heater 1050 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1050 may be implemented by a metal wire, a metal plate on which an electrically conductive track is arranged, a ceramic heating element, or the like, but is not limited thereto.

In another embodiment, the heater 1050 may be a heater of an induction heating type. For example, the heater 1050 may include a susceptor that heats an aerosol generating material by generating heat through a magnetic field applied by a coil.

The user input unit 1060 may receive information input from the user or may output information to the user. For example, the user input unit 1060 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 10, the aerosol generating device 1000 may further include a connection interface, such as a universal serial bus (USB) interface, and may connect to other external devices through the connection interface, such as the USB interface, to transmit and receive information, or to charge the battery 1040.

The memory 1070 is a hardware component that stores various types of data processed in the aerosol generating device 1000, and may store data processed and data to be processed by the controller 1010. The memory 1070 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1070 may store an operation time of the aerosol generating device 1000, the maximum number of puffs, the current number of puffs, at least one temperature profile, data on a user's smoking pattern, etc.

The communication unit 1080 may include at least one component for communication with another electronic device. For example, the communication unit 1080 may include a short-range wireless communication unit 1082 and a wireless communication unit 1084.

The short-range wireless communication unit 1082 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1084 may include a cellular network communication unit, an Internet communication unit, a computer network (e.g., local area network (LAN) or wide area network (WAN)) communication unit, or the like, but is not limited thereto. The wireless communication unit 1084 may also identify and authenticate the aerosol generating device 1000 within a communication network by using subscriber information (e.g., International Mobile Subscriber Identifier (IMSI)).

The controller 1010 may control general operations of the aerosol generating device 1000. In an embodiment, the controller 1010 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1010 may control the temperature of the heater 1050 by controlling supply of power of the battery 1040 to the heater 1050. For example, the controller 1010 may control power supply by controlling switching of a switching element between the battery 1040 and the heater 1050. In another example, a direct heating circuit may also control power supply to the heater 1050 according to a control command of the controller 1010.

The controller 1010 may analyze a result sensed by the sensing unit 1020 and control subsequent processes to be performed. For example, the controller 1010 may control power supplied to the heater 1050 to start or end an operation of the heater 1050 on the basis of a result sensed by the sensing unit 1020. As another example, the controller 1010 may control, based on a result sensed by the sensing unit 1020, an amount of power supplied to the heater 1050 and the time the power is supplied, such that the heater 1050 may be heated to a certain temperature or maintained at an appropriate temperature.

The controller 1010 may control the output unit 1030 on the basis of a result sensed by the sensing unit 1020. For example, when the number of puffs counted through the puff sensor 1026 reaches a preset number, the controller 1010 may notify the user that the aerosol generating device 1000 will soon be terminated through at least one of the display unit 1032, the haptic unit 1034, and the sound output unit 1036.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

According to various embodiments of the present disclosure, the power supplied to the heater may be controlled according to a remaining puff number, thereby appropriately controlling the user's puff cycle and smoking level.

However, the effects of the embodiments are not limited to the effects described above, and effects not mentioned may be clearly understood by those skilled in the art from the present specification and the attached drawings.

What is claimed is:

1. An aerosol generating device comprising:
a heater configured to heat at least part of an aerosol generating article;
a puff sensor configured to detect a user's puff; and
a processor electrically connected to the heater and the puff sensor,
wherein the processor is configured to
detect a remaining puff number of the aerosol generating article by using the puff sensor,
compare a detected remaining puff number with the preset puff number,
stop power supply to the heater for a preset time when the detected remaining puff number is less than the preset puff number, and
supply power to the heater after the preset time elapses, such that a temperature of the heater reaches a target temperature corresponding to the remaining puff number.

2. The aerosol generating device of claim 1, wherein the processor is further configured to supply power to the heater, based on a first temperature profile, when the detected remaining puff number is greater than or equal to the preset puff number, and supply power to the heater, based on a second temperature profile that is different from the first temperature profile, when the detected remaining puff number is less than the preset puff number.

3. The aerosol generating device of claim 2, wherein the first temperature profile and the second temperature profile are temperature profiles corresponding to the remaining puff number detected by the puff sensor.

4. The aerosol generating device of claim 2, wherein the first temperature profile includes a temperature increase section in which the temperature of the heater increases to a threshold temperature.

5. The aerosol generating device of claim 2, wherein the second temperature profile is a temperature profile in which the target temperature increases as the remaining puff number decreases.

6. The aerosol generating device of claim 1, wherein the processor is further configured to stop power supply to the heater for a preset time when no puff is detected for a threshold time after the user's puff is detected by the puff sensor, and supply power corresponding to a smallest value in a power supply range for the heater to the heater after the preset time.

7. The aerosol generating device of claim 1, wherein the processor is further configured to change the preset puff number, based on an initial temperature increase rate of the heater.

8. The aerosol generating device of claim 7, wherein the processor is further configured to change the preset puff number to a puff number less than the preset puff number when the initial temperature increase rate exceeds a threshold rate range.

9. The aerosol generating device of claim 7, wherein the processor is further configured to change the preset puff number to a puff number greater than the preset puff number when the initial temperature increase rate is less than a threshold rate range.

10. An operating method of an aerosol generating device, the operating method comprising:
detecting a remaining puff number of an aerosol generating article by using a puff sensor configured to detect a user's puff;
comparing a detected remaining puff number with a preset puff number;
stopping, for a preset time, power supply to a heater configured to heat at least part of the aerosol generating article when a detected remaining puff number is less than the preset puff number; and
supplying power to the heater after the preset time elapses, such that a temperature of the heater reaches a target temperature corresponding to the remaining puff number.

11. The operating method of claim 10, further comprising supplying power to the heater, based on a first temperature profile, when the detected remaining puff number is greater than or equal to the preset puff number; and supplying power to the heater, based on a second temperature profile that is different from the first temperature profile, when the detected remaining puff number is less than the preset puff number.

12. The operating method of claim 10, further comprising:
stopping power supply to the heater for the preset time when no puff is detected for a threshold time after the user's puff is detected by the puff sensor; and
after the preset time, supplying power corresponding to a smallest value in a power supply range for the heater to the heater.

13. The operating method of claim 10, further comprising changing the preset puff number, based on an initial temperature increase rate of the heater.

14. The operating method of claim 13, further comprising changing the preset puff number to a puff number less than the preset puff number, when the initial temperature increase rate exceeds a threshold rate range.

15. The operating method of claim 13, further comprising changing the preset puff number to a puff number greater than the preset puff number, when the initial temperature increase rate is less than a threshold rate range.
